(19) United States
(12) Patent Application Publication
(10) Pub. No.: US 2010/0189120 A1
(43) Pub. Date: Jul. 29, 2010

(54) METHOD AND SYSTEM FOR A CENTRALIZED VEHICULAR ELECTRONICS SYSTEM UTILIZING ETHERNET IN AN AIRCRAFT

(76) Inventors: Wael William Diab, San Francisco, CA (US); Michael Johas Teener, Santa Cruz, CA (US); Yongbum Kim, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/751,829

(22) Filed: Mar. 31, 2010

Related U.S. Application Data
(63) Continuation-in-part of application No. 12/196,120, filed on Aug. 21, 2008.
(60) Provisional application No. 61/014,342, filed on Dec. 17, 2007.

(51) Int. Cl. H04L 12/56

(52) U.S. Cl. 370/401

(57) ABSTRACT

Aspects of a method and system for a centralized vehicular electronics system utilizing Ethernet optimized for use in an aircraft are provided. In this regard, one or more processors and/or circuits in an aircraft may be operable to receive one or more Ethernet packets over one or more Ethernet links, generate a plurality of signals based on the received packets, wherein the plurality of signals comprise a plurality of signal formats suitable for conveyance to a plurality of electronic components in the aircraft, and output the plurality of signals to a plurality of electronic components in the aircraft. The electronic component(s) may comprise a display and/or audio output. The signals may be formatted in accordance with video and/or audio standards. The electronic component(s) may comprise an Ethernet port and the circuit(s) and/or processor(s) may be operable to communicate packets between the Ethernet port and the one or more Ethernet links.

### CROSS-REFERENCE TO RELATED APPLICATIONS/INCORPORATION BY REFERENCE

This patent application is a continuation-in-part of U.S. patent application Ser. No. 12/196,120 filed on Aug. 21, 2008 which claimed the benefit of U.S. Provisional Application Ser. No. 61/014,342 filed Dec. 17, 2007 and entitled “Method And System For Centralized Automotive Electronics System Utilizing Ethernet With Audio Video Bridging”.

This application also makes reference to: U.S. Pat. No. ______ (Attorney Docket No. 19276US03) filed on even data herewith; U.S. patent application Ser. No. 11/686,867 filed on Mar. 15, 2007; and

U.S. patent application Ser. No. 11/686,852 filed on Mar. 15, 2007.

Each of the above stated applications is hereby incorporated herein by reference in its entirety.

### FIELD OF THE INVENTION

Certain embodiments of the invention relate to vehicular electronics. More specifically, certain embodiments of the invention relate to a method and system for a centralized vehicular electronics system utilizing Ethernet with audio video bridging.

### BACKGROUND OF THE INVENTION

From staying connected, to assisting with daily tasks, to providing entertainment, electronics are becoming an increasingly important aspect of people's daily lives. Accordingly, vehicles are increasingly being equipped with advanced electronics equipment. For example, advanced stereos and sound systems, navigation equipment, back-up assist cameras, and an increasing number of diagnostic sensors are just some of the advanced electronics being installed in vehicles. Consequently, installation and interoperation of the various electronic components is becoming increasingly complicated and expensive. In this regard, the wiring alone required for communicating data to and from the various electronic devices is a major source of cost and complication in a vehicular electronic system. In this regard, specialized physical media, as is conventionally utilized in the vehicular industry, may be expensive. Additionally, existing standards for vehicular networking, such as MOST and IDB-1394, are immature and largely unproven at high data rates. Additionally, non-standardized devices, connectors, and/or protocols utilized by vehicular electronics networks may further add to the cost and complexity. Thus, conventional and traditional vehicular electronics system may be expensive, complicated, and difficult to upgrade.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a centralized vehicular electronics system utilizing Ethernet in an aircraft, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating exemplary AVB enabled Audio/Video equipment that may transmit and/or receive data over a network, in accordance with an embodiment of the invention.

FIG. 2A is a diagram illustrating transmission of data over a network, in accordance with an embodiment of the invention.

FIG. 2B is a diagram illustrating a centralized vehicular electronics system in an aircraft, in accordance with an embodiment of the invention.

FIG. 3 is a diagram illustrating an exemplary vehicular electronics network, in accordance with an embodiment of the invention.

FIG. 4 is a diagram illustrating another exemplary vehicular electronics network, in accordance with an embodiment of the invention.

FIG. 5 is a flow chart illustrating exemplary steps for communicating multimedia information and/or control information via one or more Ethernet links in a vehicle, in accordance with an embodiment of the invention.

### DETAILED DESCRIPTION OF THE INVENTION

Certain embodiments of the invention may be found in a method and system for a centralized vehicular electronics system utilizing Ethernet in an aircraft. In various embodiments of the invention, one or more processors and/or circuits in an aircraft may be operable to receive one or more Ethernet packets over one or more Ethernet links within the aircraft, generate a plurality of signals based on the communicated packets, wherein the plurality of signals comprise a plurality of signal formats suitable for conveyance to a plurality of electronic components in the aircraft, and output the plurality of signals to a plurality of electronic components in the aircraft. The circuit(s) and/or processor(s) may be operable to communicate the information utilizing audio video bridging and/or audio video bridging extensions. The electronic component(s) may comprise a display and one or more of the plurality of signals may be formatted in accordance with one or more video standards. The electronic component(s) may comprise an Ethernet port and the signals may be formatted in accordance with Ethernet standards. The circuit(s) and/or processor(s) may be operable to perform bridging, switching, and/or routing functions for communicating information between the Ethernet port and the one or more Ethernet links. The Ethernet packets may be communicated based on a profile associated with one or more devices coupled to the Ethernet port. The electronic component(s) may comprise an audio output port and one or more of the plurality of signals may be formatted in accordance with one or more audio standards. The Ethernet packets may carry an audio stream and the circuit(s) and/or processor(s) may be operable to reformat the audio stream such that the reformatted audio stream is suitable for conveyance to an audio output port. The Ethernet packets may carry a video stream and the circuit(s) and/or processor(s) may be operable to reformat the video stream such that the reformatted video stream is suitable for conveyance to a display. The electronic component(s) may comprise a motor and one or more of the plurality of signals may be a signal that controls the motor. The circuit(s) and/or processor(s) may be built into and/or mounted on a seat in an aircraft.

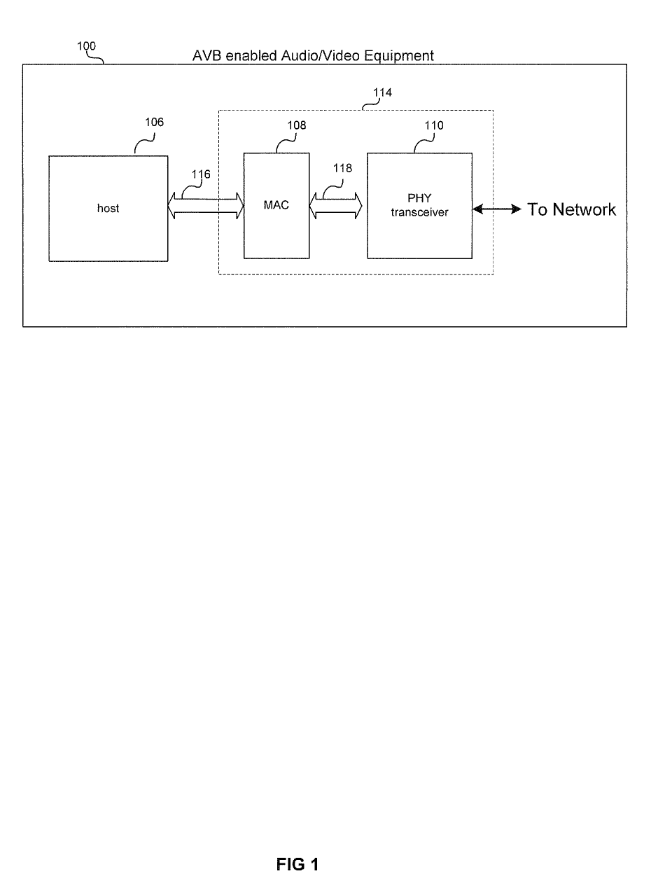

FIG. 1 is a block diagram illustrating exemplary equipment that may transmit and/or receive data over a network, in accordance with an embodiment of the invention. Referring to FIG. 1, there is shown AVB enabled equipment 100 that comprises a host 106 and a local area networking (LAN) subsystem 114. In various embodiments of the invention, the equipment may comprise a non-mission critical vehicular electronic device such as a stereo, a digital media player, a navigation system, a video camera, a display, a speaker, or another multimedia device. In various embodiments of the invention, the equipment may comprise a mission critical vehicular electronic device such as a central computing system or any of a variety of diagnostic sensors or monitors.

The host 106 may comprise suitable logic, circuitry, interfaces, and/or code that may enable operability and/or functionality of the five highest functional layers of the OSI model. In this regard, the host may process and/or generate packets that are to be transmitted over a network and process data packets received from a network. In this regard, the host 106 may execute instructions and/or run one or more applications to provide services to a local user and/or to one or more remote users or nodes in a network. In various embodiments of the invention, the host 106 may implement one or more security protocols such as IPsec. In this regard, security protocols may be of particular importance for mission-critical devices.

The LAN subsystem 114 may comprise a medium access control (MAC) module 108 and a PHY 110. In various embodiments of the invention, the LAN subsystem 114 may support a variety of data rates such as 10 Mbps, 100 Mbps, 1000 Mbps (or 1 Gbps), 2.5 Gbps, 4 Gbps, 10 Gbps, or 40 Gbps, for example. In this regard, the PHY device 110 may support standard-based data rates and/or non-standard data rates. Additionally, the LAN subsystem 114 may be operable to perform a diagnostic of the link(s) to which it may be communicatively coupled. In this manner, network problems such as open-circuited and short-circuited, e.g., from a failed connector or severed wire, links may be detected and the quality of an Ethernet link may be determined.

The LAN subsystem 114 may comprise a twisted pair PHY capable of operating at one or more standard rates such as 10 Mbps, 100 Mbps, 1 Gbps, and 10 Gbps (10BASE-T, 100GBASE-TX, 1GBASE-T, and/or 10GBASE-T); potentially standardized rates such as 40 Gbps and 100 Gbps; and/or non-standard rates such as 2.5 Gbps and 5 Gbps. The LAN subsystem 114 may comprise an optical PHY capable of operating at one or more standard rates such as 10 Mbps, 100 Mbps, 1 Gbps, and 10 Gbps; potentially standardized rates such as 40 Gbps and 100 Gbps; and/or non-standardized rates such as 2.5 Gbps and 5 Gbps. In this regard, the optical PHY may be a passive optical network (PON) PHY. The network subsystem 108ₓ may support multi-lane topologies such as 40 Gbps CR4, ER4, KR4; 100 Gbps CR10, SR10 and/or 10 Gbps LX4 and CX4. Also, serial electrical and copper single channel technologies such as KX, KR, SR, LR, LRM, SX, LX, CX, BX10, LX10 may be supported. Non-standard speeds and non-standard technologies, for example, single channel, two channel or four channels may also be supported. More over, TDM technologies such as PON at various speeds may be supported by the LAN subsystem 114.

The MAC module 108 may comprise suitable logic, circuitry, interfaces, and/or code that may enable handling of data link layer, layer 2, operability and/or functionality in the AVB enabled equipment 100. Accordingly, for egress data, the MAC 108 may receive data from the host 106, append headers or otherwise packetize the data for routing through a network, and convey the data to the PHY 110. Similarly, for ingress data, the MAC 108 may receive bits from the PHY, reassemble the bits into packets and communicate the packets to the host 106. In various embodiments of the invention, the MAC controller 108 may be configured to implement Ethernet protocols, such as those based on the IEEE 802.3 standard, for example. Additionally, the MAC controller 108 may be enabled to implement Audio Video Bridging protocols such as IEEE 801.1Qat and IEEE 802.1Qav. In this regard, various combinations of Audio/Video Bridging and Audio/Video Bridging extensions are referred to herein as Audio Video Bridging or AVB. Also, the MAC controller may be enabled to implement security protocols such as IEEE 802.1ae (MACSec) and related protocols such as IEEE 802.1af and IEEE 802.1ar.

The PHY 110 may comprise suitable logic, circuitry, interfaces, and/or code that may be operable to transmit and receive physical layer symbols over a physical medium. In this regard, the PHY 110 may receive data from the MAC 108, convert the data to one or more physical layer symbols, and impress the symbol onto the physical medium. Similarly, the PHY 110 may receive physical layer symbols, process the symbols to extract data bits represented by the symbols, and convey the data bits to the MAC 108. In various embodiments of the invention, to support AVB, the PHY 110 may be enabled to generate timestamps corresponding to the transmission and/or reception of data. In various embodiments of the invention, the PHY 110 may interface with one or more of a variety of physical media such as copper, fiber, and/or backplane. In this regard, due to the ubiquity of Ethernet, cabling or other physical media for an Ethernet network may be less costly and/or easier to obtain than cabling and/or physical media associated with other technologies.

In various embodiments of the invention, the transceiver 110a may support standard and/or extended link length and/or range of operation. Exemplary ways in which the PHY 110 may support extended link length are disclosed in U.S. patent application Ser. No. 11/686,867 filed on Mar. 15, 2007 and U.S. patent application Ser. No. 11/686,852 filed on Mar. 15, 2007, each of which is hereby incorporated herein by reference in its entirety. In this regard, although extended range may not be necessary for a vehicular electronics system, methods and systems utilized for extending the range of an Ethernet link may also be utilized to improve electromagnetic emissions and/or susceptibility of an Ethernet link. Reduced electromagnetic emissions and/or susceptibility may be desirable due to relatively high levels of interference that may be found in a vehicular electronics system. Furthermore, in an aircraft, for example, conducted and radiated emissions must be maintained below limits set by regulatory bodies to ensure that critical instrumentation of the aircraft is not interfered with. In an exemplary embodiment of the invention, data which would conventionally be communicated over ‘N’ physical channels at a first data F1 rate may be communicated over ‘M’ physical channels at a rate of F1*(N/M), where M and N are integers greater than or equal to 1.

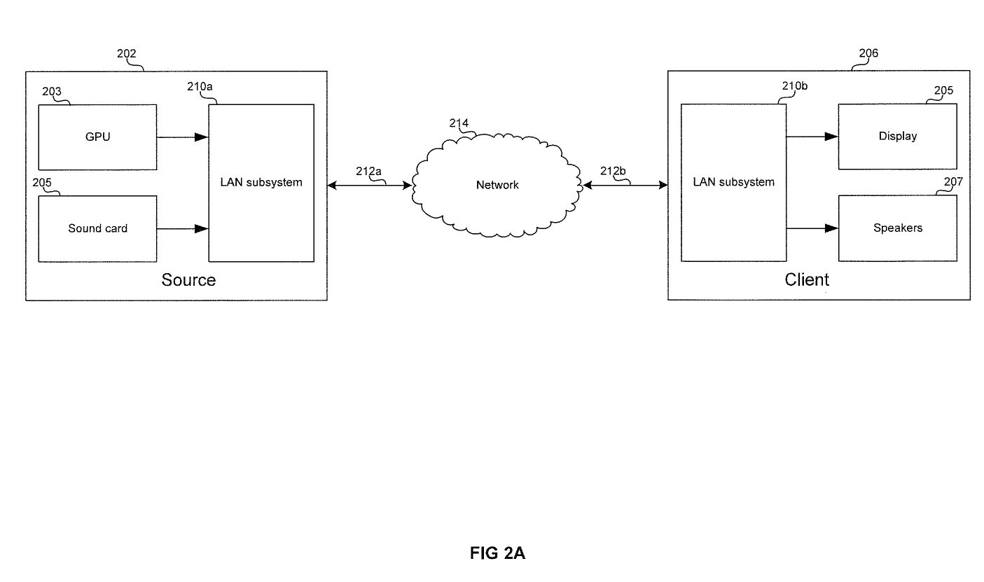

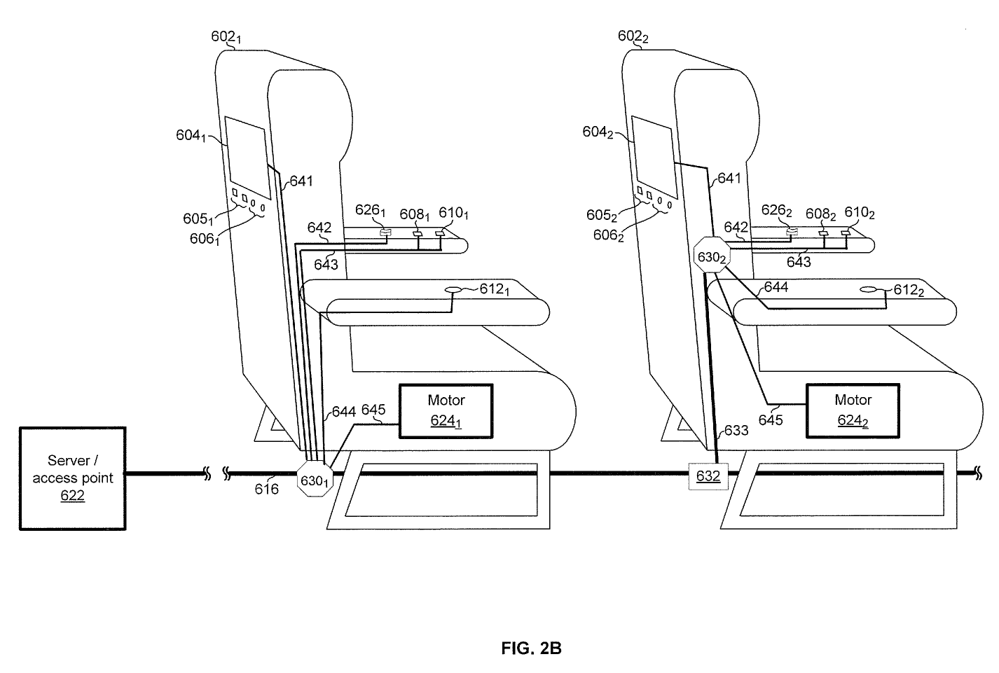

FIG. 2A is a diagram illustrating transmission of data over a network, in accordance with an embodiment of the invention. Referring to FIG. 2A there is shown exemplary non-mission critical devices comprising a source 202 and a client 206 which may exchange multimedia traffic via the network 214. Guaranteed quality of service made possible utilizing AVB may enable, for example, synchronizing audio with video while distributing the audio and video to various electronic devices in a vehicle. In this regard, audio or video may be routed to different devices and/or via a different number of devices in a vehicle. Furthermore, AVB may enable transmission of high definition multimedia streams between various components of an automotive electronics system. Additionally, AVB may enable prioritizing data to and/or from one or more electronic devices in a vehicle. For example, a cell phone may be linked to the vehicle electronics network via a Bluetooth link, and music may be paused such that audio from the cell phone may be routed to the speakers during a call.

Mission critical components of a vehicular electronics network may be similar to the source 202 and client 206, but may exchange, for example, diagnostic and or sensor information rather than, for example, multimedia or navigation information. In this regard, guaranteed quality of service made possible utilizing AVB may enable combining mission critical and non-mission critical devices into a single vehicular network rather than having separate networks for mission critical and non-mission critical devices. In this regard, mission critical information such diagnostic sensory data may be given priority in a vehicular network.

The network 214 may comprise one or more physical links and/or network hardware devices. The network 214 may comprise one or more Ethernet switches, which may be AVB enabled, and/or comprise one or more unshielded twisted pair cables with 8 position 8 conductor (8P8C) modular connectors on either end. In other embodiments of the invention, the physical links may be fiber optic cables or backplane. In an exemplary embodiment of the invention the network 214 may reside in an aircraft.

The source 202 may comprise suitable logic circuitry, interfaces, and/or code that may enable generating and/or outputting data. In this regard, the source 202 may be enabled to generate and/or process data and communicate that data to a remote client. In an exemplary embodiment of the invention, the source 202 may comprise a multimedia server located in a plane and may be similar to, or the same as, the AVB enabled equipment 100 described with respect to FIG. 1. The source 202 may, for example, generate and/or output multimedia and may comprise a GPU 203, a sound card 205, and a LAN subsystem 210a.

The GPU 203 may comprise suitable logic, circuitry, interfaces, and/or code that may enable generating graphics and/or video data. In this regard, resolution, encoding, format, compression, encryption, data rates, and/or other characteristics of video and/or graphics out of the GPU 203 may vary without deviating from the scope of the invention. For example, high definition video of 720p, 1080i, 1080p, or even higher resolution may be supported and output by the GPU 203.

The sound card 205 may comprise suitable logic, circuitry, interfaces, and/or code that may enable generating audio data. In this regard, resolution, encoding, format, compression, encryption, data rates, and/or other characteristics of an audio stream out of the sound card 205 may vary without deviating from the scope of the invention. For example, audio sample at 44.1 kHz, 96 kHz, 192 kHz or even higher may be supported and output by the sound card 205.

The LAN subsystem 210a may comprise suitable logic, circuitry, interfaces, and/or code that may enable transmitting and/or receiving data, which may be multimedia and/or time sensitive data, over a network. The LAN subsystem 210a may be similar to or the same as the LAN subsystem 114. The LAN subsystem 210a may be enabled to utilize AVB. The LAN subsystem 210 may, for example, utilize Ethernet protocols for transmitting and/or receiving data into the network 210. Additionally, the LAN subsystem may be enabled to encrypt, decrypt, format, encode, packetize, compress, decompress, or otherwise process multimedia data.

The client 206 may comprise suitable logic circuitry, interfaces, and/or code that may enable rendering and/or presenting data. For example, the client 206 may be a central computing module that may receive and process diagnostic information from one or mores sensors to control one or more functions of systems of a vehicle. Alternatively, the client 206 may be a multimedia device enabled to receive audio and/or video and process the received data for presentation to an occupant of the vehicle. In an exemplary embodiment of the invention, the client 206 may comprise, for example integrated into a passenger seat or a laptop plugged into a network port. In this regard, the client 206 may comprise a display 205, one or more speakers 207, and a LAN subsystem 210b.

The display 205 may comprise suitable logic, circuitry, interfaces, and/or code that may enable receiving video data and presenting it to a user. In this regard, the display 205 may be enabled to render, format, decompress, decrypt, or otherwise process video and/or graphics for presentation to a user.

The speaker(s) 207 may comprise suitable logic, circuitry, interfaces, and/or code that may enable receiving audio data and presenting it to a user. In this regard, the speaker(s) 207 may be enabled to render, format, decompress, decrypt or otherwise process the audio for presentation to a user.

In operation, the GPU 203 may generate video and/or graphics and may transfer the video and/or graphics to the LAN subsystem 210a for additional processing, formatting, and/or packetization according to one or more standards. In various embodiments of the invention, the GPU 203 may output raw video and/or graphics or may output video and/or graphics formatted according to, for example, DisplayPort or HDMI, standards. Additionally, the sound card 205 may generate audio and may transfer the audio to the LAN subsystem 210a for additional processing, formatting, and/or packetization according to one or more standards. In various embodiments of the invention, the sound card 205 may output uncompressed audio or may output audio formatted according to, for example, Mp3 or AAC, standards. The LAN subsystem 210a may encapsulate the multimedia data received from the GPU 203 and the sound card 205 into Ethernet frames and transmit the frames into the network 214 via the physical link 212a. For example, the source 202 may transmit video and accompanying audio into a network 214 which provides connectivity to the passenger seats in an aircraft.

The LAN subsystem 210b may receive the multimedia data over the network 214 via the physical link 212b. The LAN subsystem 210b may de-packetize, parse, format, decrypt, and/or otherwise process the received data and may convey received video data to the display 205 and may convey received audio data to the speaker(s) 207. In this regard, data formatted according to, for example, HDMI, DisplayPort, USB, or IEEE 1394 standards may be tunneled over an Ethernet link between vehicular electronic devices. In an exemplary embodiment of the invention, the LAN subsystem 210b may, for example, receive Ethernet frames and extract and/or reconstruct DP “micro-packets” from received Ethernet frames. The LAN subsystem 210b may convey the “micro-packets” to the display 205 and/or the speaker(s) 207. In an exemplary embodiment of the invention, the LAN subsystem 210b may extract the audio and/or video data from the micro-packets and convey raw video to the display 205 and raw audio to the speaker(s) 207. For example, video and accompanying audio may be rendered and presented to passengers via their laptops and/or via a display and audio system integrated into their seats.

In various embodiments of the invention, the source 202 and the client 206 may implement one or more protocols for what may be referred to as “Energy Efficient Ethernet”. For example, low-power IDLE signaling, subset PHY, and/or dynamic control of a data rate at which the source 202 and the client 206 may communicate over the links 212.

FIG. 2B is a diagram illustrating a centralized vehicular electronics system in an aircraft, in accordance with an embodiment of the invention. Referring to FIG. 2B there is shown a server and/or access point 622 and passenger seats 602₁ and 602₂.

The server and/or access point 622 may be similar to, or the same as, one or more of the equipment 100 (FIG. 1A) and the source 202 (FIG. 2). In this regard, the server and/or access point 622 may be operable to serve content, applications, and/or other data to one or more clients, where the clients may comprise, for example, devices built into one or more of the seats 602. In various embodiments of the invention, server and/or access point 622 may serve media, gaming, and/or other information and/or content. In this regard, information and/or content served may be recorded and/or may be real-time (e.g., received from a satellite or a radio tower). In various embodiments of the invention the server and/or access point 622 may have a wireless Internet connection and may provide Internet access to one or more clients. In various embodiments of the invention, the server and/or access point 622 may be operable to provide cellular and/or voice over IP (VoIP) calling services. For example, the server and/or access point 622 may function as a femtocell. Additionally or alternatively, the server and/or access point 622 may provide wireless networking, e.g. IEEE 802.11 wireless networking, and may enable passengers to make VoIP calls from their computer and/or VoIP-enabled handsets.

Although a single server and/or access point 622 is shown, a plurality of the servers and/or access points 622 may be installed in an aircraft. For example, a plurality of servers and/or access points 622 may be installed and each may serve a particular section or sections of seats 602. Each of the plurality of servers and/or access points 622 may communicate with clients via a link 616 which may be, for example, a fiber optic or copper cable. Additionally or alternatively, the plurality of the servers and/or access points 622 may be redundant systems that may, for example, increase reliability in instances that the server 622 provides information to electronic components on the flight deck.

The link 616 may also communicatively coupled various electronic components in the passenger cabin of the aircraft to one or more electronic components on the flight deck of the aircraft. For example, information from the flight deck, such as the location of the plan, may be communicated to passengers via one or more electronic components communicatively coupled to the link 616.

In various embodiments of the invention, the server and/or access point 622 may comprise, and/or be controlled via, a console or head-unit that is used by flight attendants to show content, such as safety videos and in-flight movies, to the passengers. In various embodiments of the invention, the server and/or access point 622 may provide data to instruments on the flight deck. In such instances, data to the flight deck may be given priority, e.g., utilizing AVB, over entertainment content being provided to passengers. Similarly, mission critical information provided to the flight deck may be given priority over non-mission-critical data provided to the flight deck.

Each of the seats 602₁ and 602₂ may each comprise various electronic components. Exemplary components may comprise a display 604 and associated controls 605 and inputs 606, an Ethernet port 608, a DC power port 610, a headphone jack 612, and a motor 624 and associated controls 626.

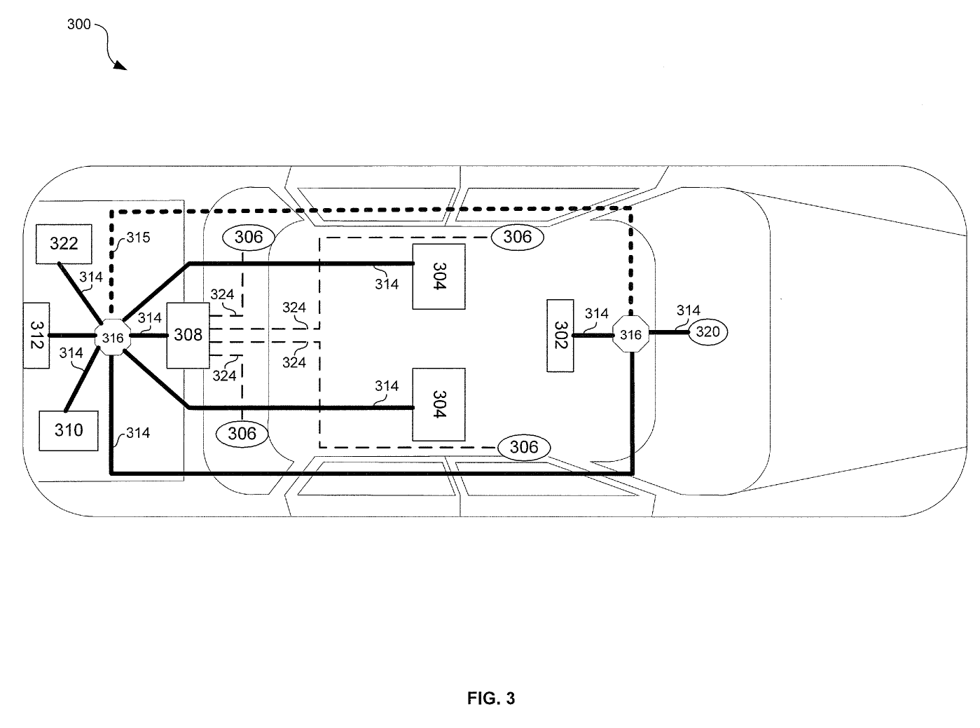

The display 604 may be similar to, or the same as, the display 304 (FIG. 3). The inputs 606 may comprise, for example, analog and/or digital audio inputs and/or outputs, analog and/or digital video inputs and/or outputs, and/or general input and/or output ports such as USB or IEEE 1394. The Ethernet port 608 may be an 8P8C connector which a passenger may connect their laptop to access a local area network of the aircraft and/or to access the Internet, for example. The controls 605 may comprise a volume control buttons, channel select buttons, gaming controls, keyboard, a touchscreen, and/or other input devices and/or interfaces.

The DC power port 610 may provide power to enable a passenger to power or charge portable electronics, for example. The DC power port 610 may comprise, for example, a powered USB port and/or a DC outlet such as may be found in a car. In various embodiments of the invention, various adaptors, power converters, and/or power inverters may be utilized to adapt the form factor and/or pin-out of the DC power port 610 and/or to adapt the voltage and/or current out of the DC power port 610. In this manner, the DC power port 610 may be compatible with a variety of electronic devices. In various embodiments of the invention, the adaptor(s), converter(s), and/or inverter(s) may be integrated into one or more of the seats 602. In various embodiments of the invention, the DC power port 604 may be powered via power delivered over the link 616.

Each motor 624 may comprise suitable logic, circuitry, interfaces, and/or code that may be operable to control a position, e.g. angle of recline and/or of a footrest, of the seat 624. Controls for controlling the position of the seat 624 may be, for example, integrated in an armrest such as controls 626 and/or may be controlled via the display 604 and controls 605.

The devices 630₁ and 630₂ may each comprise suitable logic, circuitry, interfaces, and/or code (similar to or the same as the LAN subsystem 210b) that may be operable to interface with one or more network links and interface with one or more electronic components integrated into a seat 602. Accordingly, each device 630 may be operable to perform computing and/or networking functions. In this regard, each device 630 may function as a gateway between the Ethernet link 616 and the components integrated into a seat 602. In this regard, each device 630 may perform functions of a set-top-box, a motherboard, and/or a network device such as an Ethernet bridge or switch. In this regard, each device 630 may be operable to receive packets via a port connected to the link 616, extract media and/or signals from the received packets, and convey the extracted media and/or signals, via cabling and/or wiring 641-645, to the components of the seat 602. For example, a device 630 may receive a multimedia stream received via the link 616, and may convey the video information of the stream to the display 604 and corresponding audio to the headphone jack 612. For example, the devices 630 may output multimedia to the display 604 in accordance with HDMI or DisplayPort standards. In various embodiments of the invention, the video may be communicated to the display as packetized video or as raw video. As another example, a command to return the seats 624 to an upright position may be received over the link 616 and the device 630 may output corresponding signals to the motor 624.

Similarly, a device 630 may receive media and/or signals from the components of the corresponding seat 602, packetize the media and/or signals, and communicate the packets to the server and/or access point 622. For example, a device 630 may generate requests or other control packets based on signals from the controls 605, and communicate the control and/or request packets to the server and/or access point 622. As another example, the server and/or access point 622 may have a wireless connection to the Internet and Internet data may be communicated between the server and/or access point 622 and the Ethernet port 608.

The seat 602₁ illustrates an exemplary embodiment of the invention in which a device 630 is built into or mounted to the aircraft. The device 630 may interface to, for example, a row of seats 624. In such an instance, the seats 602 may be connected to the device 630 in a star topology. The seat 602₂ illustrates an exemplary embodiment of the invention in which the device 630 is built into or mounted to the seat 602₂ and a device 632—which may be a bridge, hub, or switch, for example—may be mounted to the aircraft for each section of one or more seats 602. The seat 602₂ may be connected to a device 632 via the link 633 and additional seats 602 may be daisy chained to the seat 602₂. In this regard, the device 630 may comprise multiple Ethernet ports for daisy chaining the seats 602.

In various embodiments of the invention, a passenger may be able to, e.g., via the airline's website, establish a user profile and associated various devices, such as the passenger's laptop, with the profile. Accordingly, when the passenger is on the plane media and/or other information and/or setting may be made available, per his preferences, upon connecting his laptop to the aircraft's network. Furthermore, customized content, may be targeted to specific passengers based on associated profiles.

In various embodiments of the invention, traffic may communicate between passenger seats. For example, a first laptop connected to the Ethernet port 608₁ may be enabled with a media storage connected to the Ethernet port 608₂. In this regard, protocols such as virtual local area networking and/or AVB may be utilized for communicating information between the Ethernet ports 608₁ and 608₂.

Although FIG. 2B depicts the server 622 providing data to electronic components integrated within passenger seats, the invention is not so limited. For example, various components such as the displays 604, the controls 605, the inputs 606, the Ethernet port 608, the DC power port 610, the headphone jack 612, and the controls 626 may be integrated into overhead compartments and/or in common areas of the aircraft.

FIG. 3 is a diagram illustrating an exemplary vehicular electronics network, in accordance with an embodiment of the invention. Referring to FIG. 3, the exemplary vehicular electronics network 300 may comprise entertainment and/or navigation (NAV) equipment 302, displays 304, speakers 306, audio equipment 308, computing device 310, back-up assist camera 312, microphone 320, and entertainment equipment 322. Each of the entertainment and/or navigation system 302, displays 304, audio equipment 308, computing device 310, back-up assist camera 312, microphone 320, and entertainment equipment 322 may be similar to, or the same as, the AVB enabled equipment 100, the source 202, and/or the client 206. In this regard, the electronic components may be enabled to communicate data, including but not limited to HD multimedia streams, over the Ethernet links 314, and possibly one or more redundant links 315, utilizing Ethernet with Audio Video Bridging Protocols and/or extensions thereto. Various embodiments of the invention may comprise additional, different, and/or fewer electronic components without deviating from the scope of the invention.

In some embodiments of the invention, the Ethernet links 314 and/or 315 may comprise optical fibers. In some embodiments of the invention, the Ethernet links 314, 315, and/or the speaker wires 324 may comprise Cat-5 (or similar) cabling and the speaker wires 324 may comprise conventional speaker wire and/or Cat-5 (or similar) cabling. In other embodiments of the invention, the Ethernet links 314 and/or 315 may comprise cabling and/or connectors that may not be conventionally utilized for Ethernet but may suitable and/or desirable for a vehicular electronic network. For example, the links 314 and/or 315 may comprise cabling similar to Cat-5 cabling but with fewer than four twisted pairs to reduce cost and/or weight.

The entertainment and/or navigation equipment 302 may comprise suitable logic, circuitry, interfaces, and/or code operable to receive, distribute, and/or control multimedia and/or navigation information. The entertainment and/or navigation equipment 302 may comprise a control center for vehicle occupants to interact with the network 300. In this regard, the entertainment and/or navigation equipment 302 may enable controlling audio and/or video presented via various components of the network 300. Accordingly, the entertainment and/or navigation equipment 302 may transmit and receive data and/or control information, in Ethernet frames, to/from one or more components of the network 300 via the links 314 and/or 315. In various embodiments of the invention, the entertainment and/or navigation equipment 302 may be enabled to communicate with additional electronic devices via a wireless protocol such as Wi-Fi, Bluetooth, and/or wireless USB.

The displays 304 may comprise suitable logic, circuitry, interfaces, and/or code for presenting multimedia data. In some embodiments of the invention, Ethernet frames comprising the multimedia data may be conveyed to the display equipment 304 utilizing AVB via the Ethernet links 314. In some embodiments of the invention, raw audio and/or video may be communicated to the displays 304 via one or more twisted pairs comprising the Ethernet links 314. Additionally, the displays 304 may comprise one or more input devices, such as a touch screen, for a user to interact with one or more devices in the network 300. In this regard, control data may be communicated to and/or from the displays 304 via one or more links 314 and/or 315.

The speakers 306 may comprise suitable logic, circuitry, interfaces, and/or code for converting audio data to acoustic waves. In some embodiments of the invention, analog audio signal may be conveyed to the speakers 306 via conventional speaker wire or via twisted pairs in a Cat-5 (or similar) cable. In some embodiments of the invention, audio data encapsulated in one or more Ethernet frames may be conveyed to the speakers 306 and the speakers 306 may be operable to convert the digital audio data to analog audio before converting the analog audio to acoustic waves.

The audio equipment 308 may comprise suitable logic, circuitry, interfaces, and/or code for extracting audio from Ethernet frames and generating corresponding analog audio signals to be conveyed via the links 324. For example, the audio equipment may be an amplifier and/or cross-over. In various embodiments of the invention, the links 324 may comprise conventional speaker wire or may comprise cabling typically found in Ethernet networks, such as Cat-5 cabling. In other embodiments of the invention, the audio equipment 308 may digitally process the audio and re-encapsulate the audio data into Ethernet frames prior for communication to the speakers 306.

The computing device 310 may comprise suitable logic, circuitry, interfaces, and/or code for collecting information from one or more sensors and communicating that information over an Ethernet link 314. In this regard, data or information from sensors may be displayed visually or aurally to a driver or passenger via the network 300. Additionally, data collected by the computing device 310 may be utilized to control various portions of the vehicular electronics network 300 and/or various functions of the vehicle.

The back-up assist camera 312 may comprise suitable logic, circuitry, interfaces, and/or code that may be operable to capture images and convey those images to a display. In this regard, back-up assist camera 312 may encapsulate the captured image data into Ethernet frames and convey them, utilizing AVB, to the entertainment and/or navigation equipment 302 for viewing by the driver of the vehicle.

The microphone 320 may comprise suitable logic, circuitry, interfaces, and/or code that may be operable to convert acoustic waves into digital audio data. Audio from the microphone 320 may enable a user (driver or passenger) to control various functions of the vehicular electronics network 300 via voice commands. Additionally, the microphone 320 may enable interaction, via Bluetooth or Wi-Fi for example, with a cell phone or other portable electronic device via the vehicular electronics network 300.

The entertainment equipment 322 may comprise suitable logic, circuitry, interfaces, and/or code for outputting multimedia. In this regard, the entertainment equipment 322 may encapsulate audio and/or video into Ethernet frames and communicate the frames utilizing AVB to various portions of the network 300. In this regard, the multimedia may, for example, be played back from an optical disc or digital storage medium. In some embodiments of the invention, entertainment equipment 322 may be a video game console. Control information may be communicated utilizing AVB over to the entertainment equipment 308 from one or more other components of the network 300. In this regard, the entertainment equipment 308 may be controlled to, for example, select a desired disc, track, or file to be played back.

In the exemplary vehicular electronics network 300, the various devices may each comprise a single Ethernet port and may be communicatively coupled in a star-topology, via the nodes 316. In this regard, the nodes 316 may be similar to the AVB enabled equipment 100 described with respect to FIG. 1. The nodes 316 may be hubs, switches, bridges, or similar devices enabled to communicatively couple a plurality of AVB enabled network nodes via a corresponding plurality of links 314. The nodes 316 may be operable to perform higher layer (e.g., layer 3 and/or layer for of the OSI model) functions or protocols which may utilize, or run on top of, layer 2 Audio Video Bridging protocols. The nodes 316 may simplify the installation and wiring of the various electronic components by providing a ubiquitous Ethernet interface. Moreover, the amount and complexity of wiring may be reduced since each device may only need to be coupled to a node 316 rather than having to run all wires or cables to, for example, the entertainment and/or navigation system 302. Furthermore, the nodes 316 may provide additional and/or spare ports for reconfiguring, upgrading, and/or adding components to the vehicular electronics network 300.

In operation, the nodes 316 may route multimedia and control data, encapsulated in Ethernet packets, between the electronic devices 302, 304, 308, 310, 312, 320 and 322. AVB may be utilized to ensure quality of service for the communicated data. Connecting and disconnecting equipment to the vehicular electronics network 300 may be, for example, “plug and play” similar to or the same as a computer connecting to a conventional local area network. In this regard, an occupant of the vehicle may connect a portable or external electronic device to the vehicular electronics network 300. For example, an occupant of the vehicle may connect a laptop comprising a standard Ethernet port to the vehicular electronics network 300. In this manner, media from the laptop may be presented via, for example, the speakers 206 and the displays 304. Similarly, the laptop may be enabled to download, diagnostic, sensory, and/or recent trip data from the vehicular electronics network 300 without a need for specialized hardware or connectors. Accordingly, aspects of the invention may provide a standardized, ubiquitous, easily installed, easily maintained, and easily upgradeable vehicular electronics system.

In various embodiments of the invention, one or more redundant network links, such as the link 315 depicted as a dashed line in FIG. 3, may be present in the vehicular electronics network. In various embodiments of the invention, loops in the network may be normally blocked as a result of a spanning tree algorithm but may be utilized in the event of a network failure. Alternatively, redundant paths may be utilized to increase throughput between two or more nodes in a network.

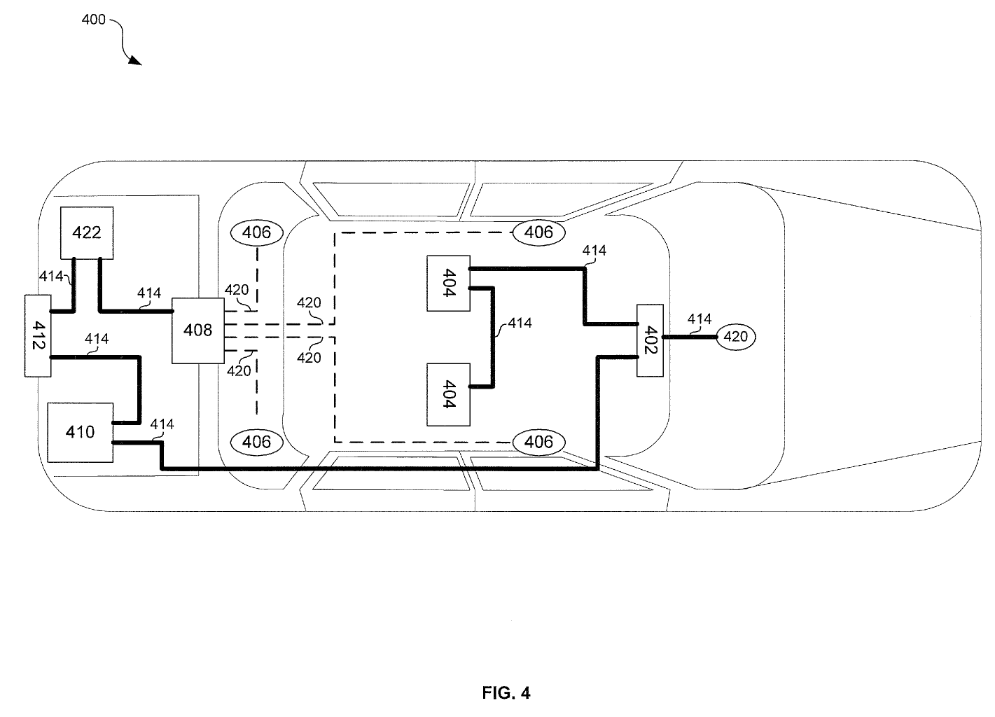

FIG. 4 is a diagram illustrating another exemplary vehicular electronics network, in accordance with an embodiment of the invention. Referring to FIG. 4, the network 400 may be similar to the network 300 and may comprise entertainment and/or navigation (NAV) equipment 402, displays 404, speakers 406, audio equipment 408, computing device 410, back-up assist camera 412, microphone 420, and entertainment equipment 422. In this regard, the various components of the network 400 may be similar to the components of the network 300 but each may comprise one or more additional network ports and associated circuitry, logic, interfaces, and/or code. In this regard, one or more of the devices of the network 400 may be operable to forward packets between two or more ports. In this manner, rather than the star topology of network 300, the components of the network 400 may be daisy chained. In this regard, the networks 300 and 400 are only exemplary and other vehicular networks may utilize a combination of star-coupled and daisy chained devices. Additionally, one or more redundant links for providing fail over operation or for increasing throughput, similar to the link 315 of FIG. 3, may be present in a vehicular electronics network utilizing any combination of star-coupled and daisy-chained devices.

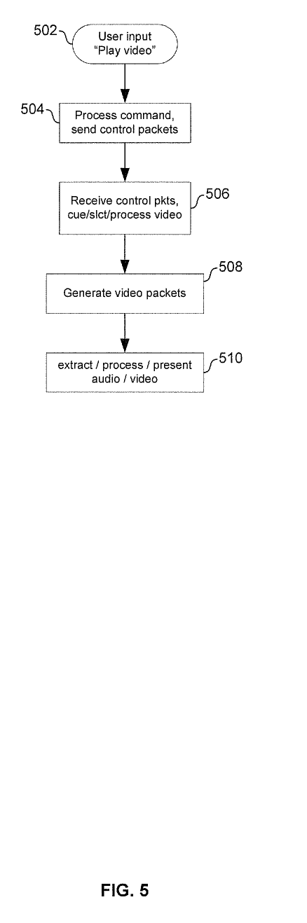

FIG. 5 is a flow chart illustrating exemplary steps for communicating multimedia information and/or control information via one or more Ethernet links in a vehicle, in accordance with an embodiment of the invention. Referring to FIG. 5, the exemplary steps may begin with step 502 when a passenger in seat 602₁ desires to play a video on the display 604₁. The passenger may interact with the entertainment system via, for example, the controls 605₁ to initiate playback of the video and accompanying audio. Subsequent to step 502, the exemplary steps may advance to step 504.

In step 504, the device 630₁ may process the user input and generate control information for communication to the server and/or access point 622. In this regard, the device 630₁ may generate one or more Ethernet packets comprising control data and may communicate, utilizing AVB, the Ethernet packets to the server and/or access point 622. Subsequent to step 504, the exemplary steps may advance to step 506.

In step 506, the server and/or access point 622 may receive and parse and/or process the Ethernet packets to determine which video source and/or file to play. For example, the control information may cause server and/or access point 622 may to select an optical disc from a plurality of optical discs or select a video file on a hard-drive for playback. Subsequent to step 506, the exemplary steps may advance to step 508.

In step 508, the server and/or access point 622 may begin reading video and accompanying audio form a source such as an optical disc, hard-drive, or solid state storage, packetize the video and audio data into Ethernet packets, and communicate, utilizing AVB, the Ethernet packets to the display 604₁, Ethernet port 608₁, and/or headphone jack 612₁ via the device 630₁. Subsequent to step 508, the exemplary steps may advance to step 510.

In step 510, the device 630₁ may receive the packets comprising the audio data, may extract and/or reconstruct the audio from the received packets, and output the audio signal(s) to the headphone jack 612₁. Exemplary processing of the extracted audio by the device 630₁ may comprise signal level adjustment, equalization, color adjustment, decryption, and decompression. In this regard, adjustment of the audio may be based on user input via the controls 605₁. In some embodiments of the invention, audio may be re-packetized into Ethernet frames for communication over an Ethernet link to the Ethernet port 608₁. In some embodiments of the invention, raw audio signals, analog baseband signals, for example, may be communicated over an Ethernet link to the device 630₁.

Also in step 510, the display 604₁ may receive, via the device 630₁, the packets comprising the video data. The display 604₁ and/or the device 630₁ may extract and/or reconstruct the video from the received packets, and present the video. Exemplary processing of the extracted video by the display 604₁ and/or the device 630₁ may comprise the signal level adjustment, equalization, color adjustment, decryption, and decompression. In this regard, adjustment of the audio may be based on user input via the controls 605₁.

Various aspects of a method and system for a centralized vehicular electronics system utilizing Ethernet optimized for use in an aircraft are provided. In an exemplary embodiment of the invention, one or more processors and/or circuits such as a device 630, for example, may be operable to receive one or more Ethernet packets over one or more Ethernet links 616 within the aircraft, generate a plurality of signals based on the communicated packets, wherein the plurality of signals comprise a plurality of signal formats suitable for conveyance to a plurality of electronic components in the aircraft, and output the plurality of signals, via wires 641-645, to a plurality of electronic components in the aircraft. The circuit(s) and/or processor(s) may be operable to communicate the information utilizing audio video bridging and/or audio video bridging extensions. The electronic component(s) may comprise a display 604 and one or more of the plurality of signals may be formatted in accordance with one or more video standards, such as HDMI. The electronic component(s) may comprise an Ethernet port 608 and the signals may be formatted in accordance with Ethernet standards. The circuit(s) and/or processor(s) may be operable to perform bridging, switching, and/or routing functions for communicating information between the Ethernet port 608 and the one or more Ethernet links 616. The Ethernet packets may be communicated based on a profile associated with one or more devices coupled to the Ethernet port 608. The electronic component(s) may comprise an audio output port 612 and one or more of the plurality of signals may be formatted in accordance with one or more audio standards. The Ethernet packets may carry an audio stream and the circuit(s) and/or processor(s) may be operable to reformat the audio stream such that the reformatted audio stream is suitable for conveyance to an audio output port 612. The Ethernet packets may carry a video stream and the circuit(s) and/or processor(s) may be operable to reformat the video stream such that the reformatted video stream is suitable for conveyance to a display 604. The electronic component(s) may comprise a motor 624 and one or more of the plurality of signals may be a signal that controls the motor 624. The circuit(s) and/or processor(s) may be built into and/or mounted on a seat 602 in an aircraft.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a centralized vehicular electronics system utilizing Ethernet optimized for use in an aircraft.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for networking, the method comprising:
in an aircraft:
receiving, utilizing Audio Video Bridging protocols, one or more Ethernet packets over one or more Ethernet links within said aircraft;
generating a plurality of signals based on said received packets, wherein said plurality of signals comprise a plurality of signal formats suitable for conveyance to a plurality of electronic components in said aircraft; and
outputting said plurality of signals to said plurality of electronic components.

2. The method according to claim 1, wherein said one or more electronic components comprise a display and one or more of said plurality of signals are formatted in accordance with one or more video standards.

3. The method according to claim 1, wherein said one or more electronic components comprise an Ethernet port and one or more of said plurality of signals are formatted in accordance with one or more Ethernet standards.

4. The method according to claim 3, comprising performing bridging, switching, and/or routing functions to communicate said received packets between said Ethernet port and said one or more Ethernet links.

5. The method according to claim 3, wherein said Ethernet packets are communicated based on a profile associated with one or more devices coupled to said Ethernet port.

6. The method according to claim 1, wherein said one or more electronic components comprise an audio output port and one or more of said plurality of signals are formatted in accordance with one or more audio standards.

7. The method according to claim 1, wherein said one or more Ethernet packets carry an audio stream and said one or more circuits and/or processors are operable to reformat said audio stream such that said reformatted audio stream is suitable for conveyance to an audio output port.

8. The method according to claim 1, wherein said one or more Ethernet packets carry a video stream and said one or more circuits and/or processors are operable to reformat said video stream such that said reformatted video stream is suitable for conveyance to a display.

9. The method according to claim 1, wherein said one or more electronic components comprise a motor and one or more of said plurality of signals is a signal that controls said motor.

10. The method according to claim 1, wherein said one or more circuits and/or processors are built into and/or mounted on a seat in said aircraft.

11. A system for networking, the method comprising:
one or more circuits and/or processors for use in an aircraft, said one or more circuits being operable to:
receive, utilizing Audio Video Bridging protocols, one or more Ethernet packets over one or more Ethernet links within said aircraft;
generate a plurality of signals based on said received packets, wherein said plurality of signals comprise a plurality of signal formats suitable for conveyance to a plurality of electronic components in said aircraft; and
output said plurality of signals to said plurality of electronic components.

12. The system according to claim 11, wherein said one or more electronic components comprise a display and one or more of said plurality of signals are formatted in accordance with one or more video standards.

13. The system according to claim 11, wherein said one or more electronic components comprise an Ethernet port and one or more of said plurality of signals are formatted in accordance with one or more Ethernet standards.

14. The system according to claim 13, wherein said one or more circuits and/or processors are operable to perform bridging, switching, and/or routing functions to communicate said received packets between said Ethernet port and said one or more Ethernet links.

15. The system according to claim 13, wherein said Ethernet packets are communicated based on a profile associated with one or more devices coupled to said Ethernet port.

16. The system according to claim 11, wherein said one or more electronic components comprise an audio output port and one or more of said plurality of signals are formatted in accordance with one or more audio standards.

17. The system according to claim 11, wherein said one or more Ethernet packets carry an audio stream and said one or more circuits and/or processors are operable to reformat said audio stream such that said reformatted audio stream is suitable for conveyance to an audio output port.

18. The system according to claim 11, wherein said one or more Ethernet packets carry a video stream and said one or more circuits and/or processors are operable to reformat said video stream such that said reformatted video stream is suitable for conveyance to a display.

19. The system according to claim 11, wherein said one or more electronic components comprise a motor and one or more of said plurality of signals is a signal that controls said motor.

20. The system according to claim 11, wherein said one or more circuits and/or processors are built into and/or mounted on a seat in said aircraft.
